(19) United States
(12) Patent Application Publication
(10) Pub. No.: US 2018/0308016 A1
(43) Pub. Date: Oct. 25, 2018

(54) METHOD FOR ALLOCATING LOGISTICAL TRAVEL RESOURCES

(71) Applicant: Tripaly, LLC, Austin, TX (US)

(72) Inventor: Jyotpal Singh, Austin, TX (US)

(21) Appl. No.: 15/952,927

(22) Filed: Apr. 13, 2018

Related U.S. Application Data
(60) Provisional application No. 62/485,171, filed on Apr. 13, 2017.

(51) Int. Cl. G06Q 10/02; G06Q 30/06

(52) U.S. Cl. CPC G06Q 10/025; G06Q 50/14; G06Q 30/0631

(57) ABSTRACT

Methods for allocating logistical travel resources. In one embodiment, the method includes selecting an inventory of trip packages based in part on user preferences. The trip packages include transport link resource allocations between a departure location and a plurality of destination locations, and lodging allocations for the plurality of destination locations. The method also includes presenting the inventory of trip packages to a plurality of users through a user interface over a communication network. Responsive to receiving trip booking requests from the plurality of users, the method further includes allocating the transport link resource allocations and the lodging allocations, and allocating user financial time commitments.

### CROSS-REFERENCE TO RELATED APPLICATION AND CLAIM OF PRIORITY

This application claims priority to U.S. Provisional Application No. 62/485,171, filed Apr. 13, 2017, entitled “METHOD FOR ALLOCATING LOGISTICAL TRAVEL RESOURCES,” which is hereby incorporated by reference in its entirety.

### BACKGROUND AND DESCRIPTION OF RELATED ART

Spontaneous trips (or surprise trips) are a recent trend in the travel industry. These spontaneous trips are often short trips (for example, 2-day or 3-day weekend trip) and are often booked last minute (for example, less than one week prior to taking the trip). The travel industry currently provides many different on-line tools to assist users in finding travel options, tracking prices for travel options, and booking travel option. However, it is time consuming for users to manually sift through all of the available travel data provided. Some travel booking internet websites and mobile device applications help users book travel by gathering and providing lists of potential transportation and lodging options in response to the users providing travel dates, departure locations, and destination locations. While these services reduce the amount of time needed for users to search for flights and hotels, users are still required to select each separate travel options for a trip from the provided lists and provide an extensive amount of information in order to book all of the selected travel options.

### SUMMARY

The disclosure provides systems and methods which enable users to view and book trip packages on their electronic user devices (for example, smartphones and laptop computers) without needing to perform the searching, pricing, and booking functions required by current travel industry tools. In other words, the disclosed systems and methods provide users with a mobile travel agency in their pocket. In addition, the disclosed systems and methods select trip packages to offer to users based on user interests.

Thus, one embodiment provides a method for allocating logistical travel resources. The method includes selecting an inventory of trip packages based in part on user preferences. The trip packages include transport link resource allocations between a departure location and a plurality of destination locations, and lodging allocations for the plurality of destination locations. The method also includes presenting the inventory of trip packages to a plurality of users through a user interface over a communication network. Responsive to receiving trip booking requests from the plurality of users, the method further includes allocating the transport link resource allocations and the lodging allocations, and allocating user financial time commitments.

Another embodiment provides a method for allocating logistical travel resources. The method includes selecting an inventory of trip packages based in part on user preferences. The trip packages include transport link resource allocations between a departure location and a plurality of destination locations, and lodging allocations for the plurality of destination locations. The method also includes presenting the inventory of trip packages to a user through a user interface over a communication network. Responsive to receiving a trip booking request from the user for a first trip package included in the inventory of trip packages, the method further includes allocating a transport link resource allocation and a lodging allocation of the first trip package to the user. The method also includes allocating a user financial time commitment to the user. The method further includes communicating reservation data to the user through the user interface over the communication network.

Other aspects and embodiments will become apparent by consideration of the detailed description and accompanying drawings.

### BRIEF DESCRIPTION OF THE DRAWINGS

FIG. 1 is a diagram of a trip package allocation system, in accordance with some embodiments.

FIG. 2 is a diagram of an electronic user device included in the trip package allocation system of FIG. 1, in accordance with some embodiments.

FIG. 3 is a diagram of a server included in the trip package allocation system of FIG. 1, in accordance with some embodiments.

FIG. 4 is a flowchart of a method of selecting and allocating logistical travel resources, in accordance with some embodiments.

FIGS. 5A and 5B are example screenshots of departure location selection on a user interface included in the electronic user device of FIG. 2, in accordance with some embodiments.

FIGS. 6A-6C are example screenshots of trip package selection and trip details on a user interface included in the electronic user device of FIG. 2, in accordance with some embodiments.

FIGS. 7A-7D are example screenshots of trip package booking confirmation and activity allocations on a user interface included in the electronic user device of FIG. 2, in accordance with some embodiments.

FIG. 8 is a module diagram of a system for selecting and allocating trip packages, in accordance with some embodiments.

FIG. 9 is a flowchart of a method of selecting and allocating trip packages, in accordance with some embodiments.

### DETAILED DESCRIPTION

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments illustrated.

The apparatus and method components have been represented where appropriate by conventional symbols in the drawings, showing only those specific details that are pertinent to understanding various embodiments so as not to obscure the disclosure with details that will be readily apparent to those of ordinary skill in the art having the benefit of the description herein.

Before any embodiments are explained in detail, it is to be understood that no embodiment is necessarily limited in its application to the details of construction and the arrangement of components set forth in the following description or illustrated in the following drawings. Other embodiments are possible and embodiments described are capable of being practiced or of being carried out in various ways.

It should also be noted that a plurality of different structural components may be utilized to implement the disclosure. Furthermore, and as described in subsequent paragraphs, the specific configurations illustrated in the drawings are intended to exemplify certain embodiments. Alternative configurations are possible.

For ease of description, the example systems presented herein may be illustrated with a single exemplar of each of their component parts. Some examples may not describe or illustrate all components of the systems. Other example embodiments may include more or fewer of each of the illustrated components, may combine some components, or may include additional or alternative components.

Some embodiments include a system for allocating logistical travel resources. In some embodiments, the system includes a server executing an inventory management module for selecting, based in part on user preferences, an inventory of trip packages including transport link resource allocations between a departure location and a plurality of destination locations, and lodging allocations for the plurality of destination locations. In some embodiments, the system includes a user interface module for presenting the inventory of trip packages to a user through a user interface over a communication network. In some embodiments, the system includes a reservation management module for, responsive to receiving a trip booking request from the user for a first trip package included in the inventory of trip packages, allocating a transport link resource allocation and a lodging allocation of the first trip package to the user, allocating a user financial time commitment to the user, and communicating reservation data to the user through the user interface over the communication network.

In some embodiments, the system includes instructions within the user interface module for, responsive to receiving the trip booking request, the user interface module presenting, to the user through the user interface over the communication network, an inventory of activities based on a destination location of the first trip package.

In some embodiments, the system includes, instructions within the reservation management module for, responsive to receiving an activity booking request from the user for a first activity included in the inventory of activities, the reservation management module allocating an activity allocation of the first activity to the user, and allocating additional user financial time commitments to the user.

In some embodiments, the allocating the transport link resource allocation of the first trip package to the user further includes retrieving biographical data of the user, the biographical data of the user having been stored prior to receiving the trip booking request and transmitting a transport reservation signal including at least a portion of the biographical data of the user. In some embodiments, the biographical data of the user includes at least one selected from a group consisting of a name, a birthday, a loyalty program identifier, and a known traveler number.

In some embodiments, the system includes a behavior observation module for retrieving a first set of observational data from a memory, the first set of observational data indicating user viewership of the inventory of trip packages and having been stored prior to receiving the trip booking request. In some embodiments, the system includes a trend analysis module for determining a booking trend for the user based in part on the first set of observational data and the trip booking request. In some embodiments, the system includes a data store for storing the booking trend for the user in the memory.

In some embodiments, the inventory of trip packages is a first inventory of trip packages, the user interface module is further configured for presenting a second inventory of trip packages to the user through the user interface over the communication network, the behavior observation module is further configured for receiving a second set of observational data from the user interface over the communication network, the second set of observational data indicating the user viewership of the second inventory of trip packages, and the trend analysis module is further configured for determining a booking probability factor based in part on the booking trend for the user and the second set of observational data. In some embodiments, communicating the reservation data to the user further includes providing status updates for the transport link resource allocations and the lodging allocations to the user through the user interface over the communication network.

Some embodiments include a method for allocating logistical travel resources. In some embodiments, the method includes selecting, based at least in part on user preferences, an inventory of trip packages including at least one or more transport link resource allocations between a departure location and a plurality of destination locations, and one or more lodging allocations for the plurality of destination locations. In some embodiments, the method includes presenting the inventory of trip packages to a plurality of users through a user interface over a communication network. In some embodiments, the method includes responsive to receiving trip booking requests from at least one of the plurality of users, allocating the transport link resource allocations and the lodging allocations, and allocating user financial time commitments. In some embodiments, the user preferences include at least one selected from a group consisting of trip types, user interests, and destination location types.

In some embodiments, the method includes determining the user preferences based at least in part on user-provided preference data of the plurality of users received through the user interface over the communication network, user trait data of the plurality of users received over the communication network from one or more consumer tracking databases, and observational data of the plurality of users received through the user interface over the communication network. In some embodiments, the method includes determining the user preferences based at least in part on incidentally-gathered data received from electronic user devices of the plurality of users over the communication network.

In some embodiments, the method includes receiving, through the user interface over the communication network, observational data indicating user viewership of the inventory of trip packages and adjusting the inventory of trip packages based at least in part on the observational data. In some embodiments, adjusting the inventory of trip packages based in part on the observational data further includes determining, based at least in part on the observational data, an interest level of a trip type included in the inventory of trip packages and adding additional trip packages of the trip type to the inventory of trip packages when the determined interest level is above a threshold.

In some embodiments, the threshold is a first threshold, and adjusting the inventory of trip packages based in part on the observational data further includes removing trip packages of the trip type from the inventory of trip packages when the determined interest level is below a second threshold, wherein the second threshold is less than the first threshold. In some embodiments, the method includes adjusting the inventory of trip packages based in part on pricing data for the transport link resource allocations and the lodging allocations of the inventory of trip packages. In some embodiments, allocating the user financial time commitments further includes comparing the user financial time commitments to user financial time credits of the plurality of users and committing the plurality of users to additional financial payments when the user financial time commitments are greater than the user financial time credits. In some embodiments, the method includes supplying, to the plurality of users through the user interface over the communication network, status updates for the transport link resource allocations and the lodging allocations during a time period for which trip packages are booked.

Some embodiments include a computer program product in a computer readable medium for allocating logistical travel resources, the computer program product in a computer readable medium including instructions for selecting, based in part on user preferences, an inventory of trip packages including transport link resource allocations between a departure location and a plurality of destination locations, and lodging allocations for the plurality of destination locations. In some embodiments, the computer program product includes instructions for presenting the inventory of trip packages to a user through a user interface over a communication network. In some embodiments, the computer program product includes instructions for, responsive to receiving a trip booking request from the user for a first trip package included in the inventory of trip packages, allocating a transport link resource allocation and a lodging allocation of the first trip package to the user, allocating a user financial time commitment to the user, and communicating reservation data to the user through the user interface over the communication network.

In some embodiments, the computer program product includes instructions for, responsive to receiving the trip booking request, presenting, to the user through the user interface over the communication network, an inventory of activities based on a destination location of the first trip package. In some embodiments, the computer program product includes instructions for, responsive to receiving an activity booking request from the user for a first activity included in the inventory of activities, allocating an activity allocation of the first activity to the user and allocating additional user financial time commitments to the user. In some embodiments the instructions for allocating the transport link resource allocation of the first trip package to the user further include instructions for retrieving biographical data of the user, the biographical data of the user having been stored prior to receiving the trip booking request and transmitting a transport reservation signal including at least a portion of the biographical data of the user.

In some embodiments, the biographical data of the user includes at least one selected from a group consisting of a name, a birthday, a loyalty program identifier, and a known traveler number. In some embodiments, the computer program product includes instructions for retrieving a first set of observational data from a memory, the first set of observational data indicating user viewership of the inventory of trip packages and having been stored prior to receiving the trip booking request, determining a booking trend for the user based in part on the first set of observational data and the trip booking request, and storing the booking trend for the user in the memory.

In some embodiments the inventory of trip packages is a first inventory of trip packages, wherein the computer program product in a computer readable medium further includes instructions for presenting a second inventory of trip packages to the user through the user interface over the communication network, receiving a second set of observational data from the user interface over the communication network, the second set of observational data indicating the user viewership of the second inventory of trip packages, and determining a booking probability factor based in part on the booking trend for the user and the second set of observational data. In some embodiments, the instructions for communicating the reservation data to the user further include instructions for providing status updates for the transport link resource allocations and the lodging allocations to the user through the user interface over the communication network.

Some embodiments include a method for allocating logistical travel resources. In some embodiments, the method includes selecting, based in part on user preferences, an inventory of trip packages including transport link resource allocations between a departure location and a plurality of destination locations and lodging allocations for the plurality of destination locations. In some embodiments, the method includes presenting the inventory of trip packages to a user through a user interface over a communication network, and responsive to receiving a trip booking request from the user for a first trip package included in the inventory of trip packages allocating a transport link resource allocation and a lodging allocation of the first trip package to the user, allocating a user financial time commitment to the user, and communicating reservation data to the user through the user interface over the communication network.

In some embodiments, the method further includes, responsive to receiving the trip booking request, presenting, to the user through the user interface over the communication network, an inventory of activities based on a destination location of the first trip package. In some embodiments, the method further includes, responsive to receiving an activity booking request from the user for a first activity included in the inventory of activities, allocating an activity allocation of the first activity to the user, and allocating additional user financial time commitments to the user. In some embodiments, the method further includes, retrieving biographical data of the user, the biographical data of the user having been stored prior to receiving the trip booking request and transmitting a transport reservation signal including at least a portion of the biographical data of the user. In some embodiments the biographical data of the user includes at least one selected from a group consisting of a name, a birthday, a loyalty program identifier, and a known traveler number.

In some embodiments, the method further includes retrieving a first set of observational data from a memory, the first set of observational data indicating user viewership of the inventory of trip packages and having been stored prior to receiving the trip booking request, determining a booking trend for the user based in part on the first set of observational data and the trip booking request, and storing the booking trend for the user in the memory. In some embodiments, the inventory of trip packages is a first inventory of trip packages, and the method further includes presenting a second inventory of trip packages to the user through the user interface over the communication network, receiving a second set of observational data from the user interface over the communication network, the second set of observational data indicating the user viewership of the second inventory of trip packages, and determining a booking probability factor based in part on the booking trend for the user and the second set of observational data. In some embodiments, communicating the reservation data to the user further includes providing status updates for the transport link resource allocations and the lodging allocations to the user through the user interface over the communication network.

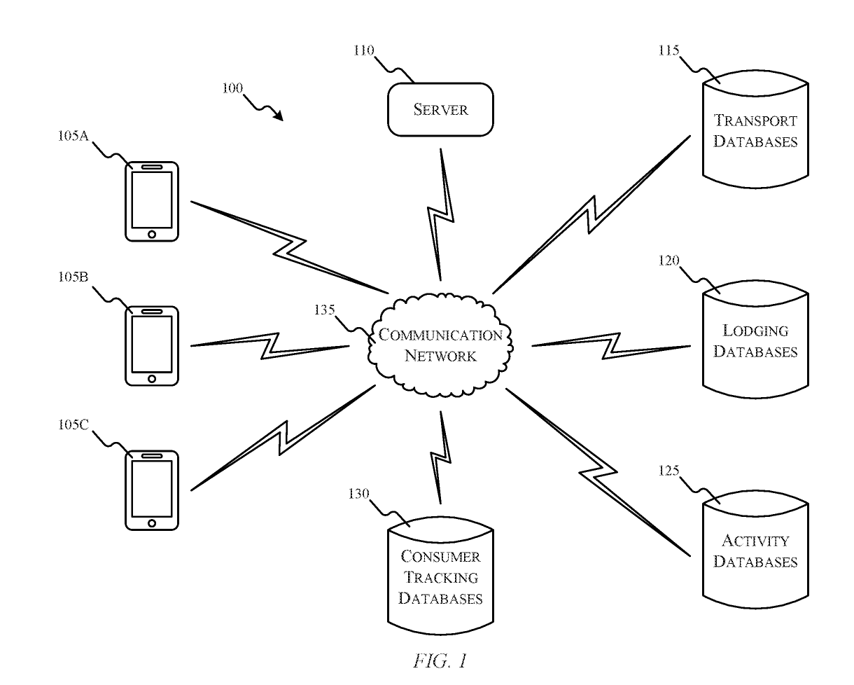

FIG. 1 is a diagram of one example embodiment of a trip package allocation system 100. The trip package allocation system 100 includes electronic user devices 105A, 105B, and 105C, a server 110, transport databases 115, lodging databases 120, activity databases 125, consumer tracking databases 130, and a communication network 135.

The electronic user devices 105A, 105B, and 105C are illustrated in FIG. 1 as smartphones. In some embodiments, the electronic user devices 105A, 105B, and 105C include smartphones, tablets, laptops, desktops, or a combination thereof. As described in more detail below, the electronic user devices 105A, 105B, and 105C collect and transmit different types of user data to the server 110 via the communication network 135.

The communication network 135 may be a wired network, a wireless network, or both. All or parts of the communication network 135 may be implemented using various networks, for example, a cellular network, the Internet, a Bluetooth™ network, a wireless local area network (for example, Wi-Fi), a wireless accessory Personal Area Networks (PAN), cable, an Ethernet network, satellite, a machine-to-machine (M2M) autonomous network, and a public switched telephone network. The electronic user devices 105A, 105B, and 105C, the server 110, and the other various components of the trip package allocation system 100 communicate with each other over the communication network 135 using suitable wireless or wired communication protocols. In some embodiments, communications with other external devices (not shown) occur over the communication network 135.

The trip package allocation system 100 illustrated in FIG. 1 is provided as one example of such a system. The methods described herein may be used with allocation systems with fewer, additional, or different components in different configurations than the trip package allocation system 100 illustrated in FIG. 1. For example, in some embodiments, the trip package allocation system 100 includes fewer or additional electronic user devices and may include fewer or additional servers.

FIG. 2 is a diagram of one example embodiment of the electronic user device 105. The electronic user device 105 may be any of the electronic user devices 105A, 105B, or 105C illustrated in FIG. 1. In the embodiment illustrated, the electronic user device 105 includes an electronic processor 205 (for example, a microprocessor, or other electronic controller), a memory 210, a transceiver 215, a microphone 220, a speaker 225, a user interface 230, and a camera 235. The electronic processor 205, the memory 210, as well as the other various modules are coupled by a bus 240, or are coupled directly, by one or more additional control or data buses, or a combination thereof. In alternate embodiments, the electronic user device 105 may include fewer or additional components in configurations different from the configuration illustrated in FIG. 2.

The memory 210 may include read only memory (ROM), random access memory (RAM), other non-transitory computer-readable media, or a combination thereof. The electronic processor 205 is configured to retrieve program instructions and data from the memory 210 and execute, among other things, instructions to perform the methods described herein.

The transceiver 215 transmits signals to the communication network 135 and receives signals from the communication network 135. In some embodiments, signals include, for example, data, data packets, or any combination thereof. In some embodiments, the transceiver 215 includes a separate transmitter and receiver.

The microphone 220 detects sound and outputs analogous electric signals representing the sound to the electronic processor 205. The speaker 225 receives electric signals from the electronic processor 205 and outputs sound.

The user interface 230 displays visual output generated by software applications executed by the electronic processor 205. Visual output includes, for example, graphical indicators, lights, colors, text, images, internet webpages, graphical user interfaces (GUIs), combinations of the foregoing, and the like. The user interface 230 includes a suitable display mechanism for displaying the visual output (for example, a light-emitting diode (LED) screen, a liquid crystal display (LCD) screen, an organic LED (OLED) screen, and the like).

In some embodiments, the user interface 230 includes a touch sensitive interface (for example, a touch-screen display). The touch-screen display receives user input using detected physical contact (for example, detected capacitance or resistance). Based on the user input, the touch-screen display outputs signals to the electronic processor 205 which indicate positions on the touch-screen display currently being selected by physical contact. Alternatively or in addition, the user interface 230 receives user input from a plurality of input devices such as a keyboard, a mouse, a trackpad, and the like.

The camera 235 includes one or more optical sensors that capture and convert incident light into electrical signals. For example, the camera 235 includes charged-coupled devices (CCDs) or complementary metal-oxide-semiconductor (CMOS) devices that capture an image, a series of images, video, and the like.

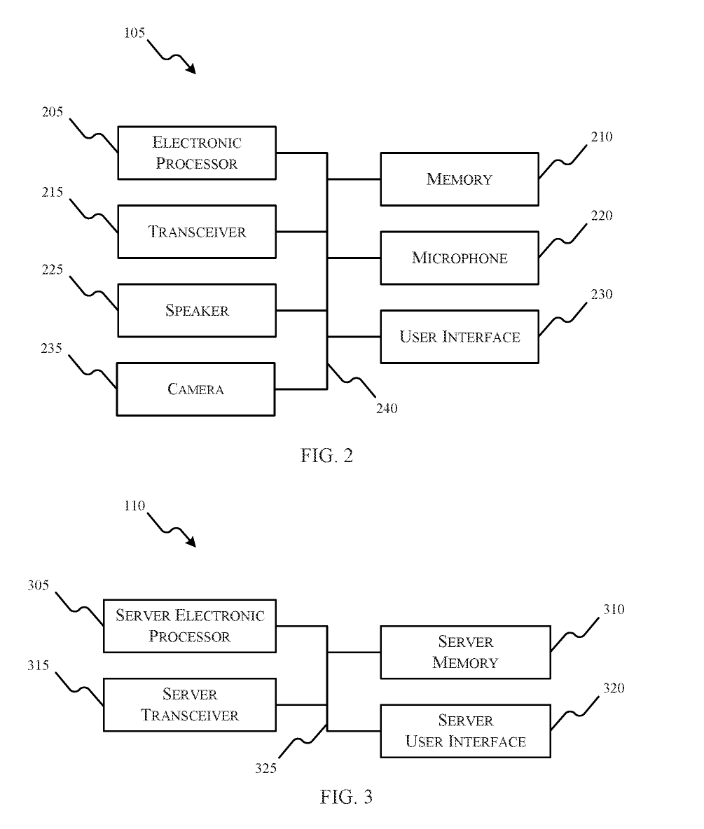

FIG. 3 is a diagram of one example embodiment of the server 110. In the example illustrated, the server 110 includes a server electronic processor 305, server memory 310, a server transceiver 315, and a server user interface 320. The server electronic processor 305, the server memory 310, as well as the other various modules are coupled by a bus 325, or are coupled directly, by one or more additional control or data buses, or a combination thereof. In other embodiments, the server 110 may include fewer or additional components in configurations different from that illustrated in FIG. 3.

The server memory 310 stores program instructions and data. The server memory 310 may include combinations of different types of memory, including the various types of memory described above with respect to the memory 210 included in the electronic user device 105. The server electronic processor 305 retrieves program instructions from the server memory 310 and executes the instructions to perform a set of functions including all or part of the methods described herein. The server transceiver 315 transmits signals to and receives signals from the electronic user device 105 and the other components included in the trip package allocation system 100, such as through the communication network 135 or directly. In some embodiments, signals include, for example, data, data packets, or any combination thereof. The server user interface 320 includes any combination of digital and analog input devices required to achieve a desired level of control for the server 110. For example, the server user interface 320 can include a computer having a display and input devices, a display, a keyboard, a mouse, speakers, and the like.

In some embodiments, the transport databases 115, the lodging databases 120, the activity databases 125, and the consumer tracking databases 130 include components or combinations of different components, including all or some of the various components described above with respect to the server 110.

As described in more detail below, the trip package allocation system 100 allows users to view and book trip packages on the electronic user device 105 without needing to perform searching, pricing, and booking functions. For example, the trip package allocation system 100 allows users to view an inventory of trip packages on the electronic user device 105 and book a trip package with minimum user input (for example, one-click trips). In some embodiments, users view and book trip packages via a trip booking application (for example, a software program) installed in the memory 210 of the electronic user device 105. Alternatively or in addition, users view and book trip packages via a trip booking internet website accessible to the electronic user device 105.

Trip packages include, among other things, transport link resource allocations and lodging allocations. Transport link resource allocations include, among other things, airline travel tickets. In some embodiments, transport link resource allocations also include ground transportation. For example, transport link resource allocation can include shuttle bus reservations, limousine reservations, taxicab reservations, ride-sharing credits, and public transportation credits. Lodging allocations include, among other things, hotel reservations, resort reservations, motel reservations, and short-term lodging rental reservations.

In some embodiments, users pay a monthly fee which entitles them to book a set number of trip packages per year. For example, users pay $100 a month and are entitled to book four trip packages a year. A user financial time commitment is required to book a trip package. A user financial time commitment includes a number of monthly payments. For example, a first user financial time commitment includes three months of payment. Monthly payments made by users entitle the users to user financial time credits. User financial time credits include the number of monthly payments that users have made, but have not yet been allocated to book trip packages. For example, four months of payments entitle a first user to a user financial time credit of four months. In some embodiments, all of the trip packages include the same user financial time commitment. For example, every trip package includes a user financial time commitment of three months of payment. In alternate embodiments, different levels (or tiers) of trip packages include different user financial time commitments. For example, a lower level trip package includes a user financial time commitment of three months of payment, and a higher level trip package includes a user financial time commitment of four months of payment. In some embodiments, users pay upon booking a trip package.

The server 110 determines potential combinations of transport link resource allocations and lodging allocations to include in trip packages based in part on information received from the transport databases 115, the lodging databases 120, or both. Examples of transport databases 115 and lodging databases 120 include Sabre, Amadeus, Travelport GDS, and ITA. In some embodiments, the server 110 receives information from the transport databases 115 such as travel dates, departure locations, destination locations, departure times, arrival times, airlines, flight numbers, flight durations, prices, and the like. In some embodiments, the server 110 receives information from the lodging databases 120 such as hotel names, hotel locations, hotel quality (for example, number of stars), hotel amenities, room types, prices, and the like. In some embodiments, the server 110 receives information regarding transport link resource allocations from the transport databases 115 and information regarding lodging allocations from the lodging databases 120. In alternate embodiments, the server 110 receives information regarding transport link resource allocations and lodging allocations from one or more of the same databases.

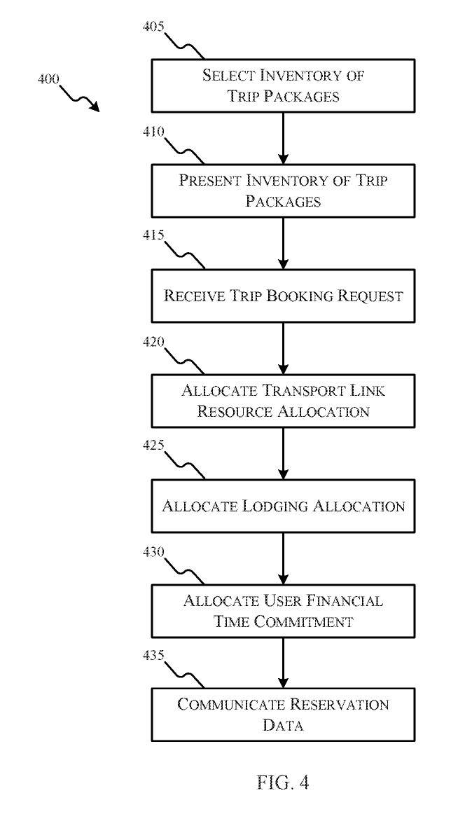

FIG. 4 illustrates an example method 400 for selecting and allocating logistical travel resources. For ease of description, the transport link resource allocation included in each trip package discussed below in connection to method 400 includes a round-trip air transportation reservation between a departure location and a destination location. In addition, the lodging allocation included in each trip package discussed below in connection to method 400 includes a hotel reservation.

In the example illustrated, the method 400 includes, at block 405, selecting, for example, via the server electronic processor 305, an inventory of trip packages based in part on user preferences. User preferences include, among other things, trip types (for example, relaxation, culture, and action), user interests (for example, eating, drinking, museums, historical sights, shopping, live entertainment, skiing, and music), and destination location types (for example, warm climate, major city, beach resort, and outdoor).

At block 410, the inventory of trip packages is presented to a plurality of users through the user interface 230 over the communication network 135. For example, the server electronic processor 305 transmits the inventory of trip packages to the electronic user devices 105A, 105B, and 105C via the server transceiver 315. Upon receiving the inventory of trip packages, the electronic user devices 105A, 105B, and 105C display the inventory of trip packages via the user interface 230.

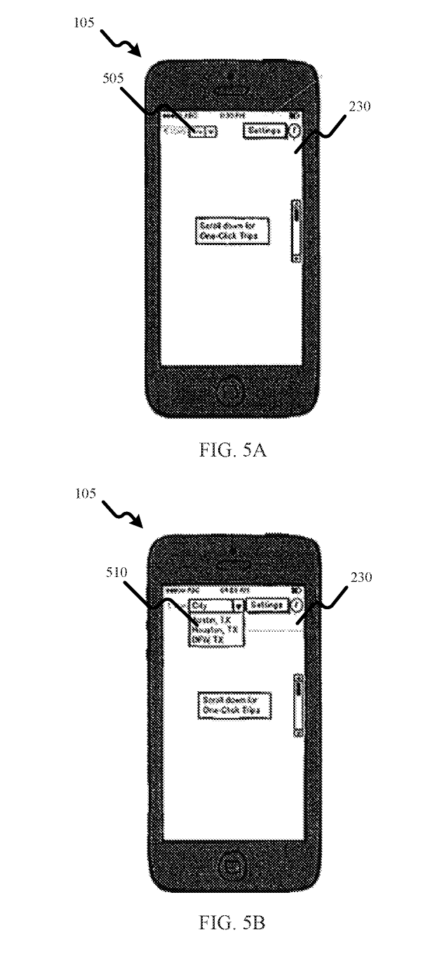

In some embodiments, the entire inventory of trip packages is not presented to each user. Rather, each user is presented with a subset of the inventory of trip packages based on a determined departure location for that user (for example, a departure city or airport). In some embodiments, the departure location for a user is determined based on a user profile stored, for example, in the server memory 310. For example, the electronic processor 205 determines a default departure location 505 for a user based on the user's profile and displays the default departure location 505 on the user interface 230, as illustrated in FIG. 5A. Alternatively or in addition, the departure location for a user is determined based on user input. For example, the electronic processor 205 changes the departure location for the user from the default departure location 505 when the user selects a different departure location from a plurality of departure locations 510, as illustrated in FIG. 5B. In some embodiments, the electronic processor 205 detects, based on signals received from the user interface 230, when a user's finger touches a different departure location from a plurality of departure locations 510 on the user interface 230, and changes the departure location for the user from the default departure location 505 to the selected departure location. After the departure location is set, the electronic processor 205 displays the trip packages on the user interface 230.

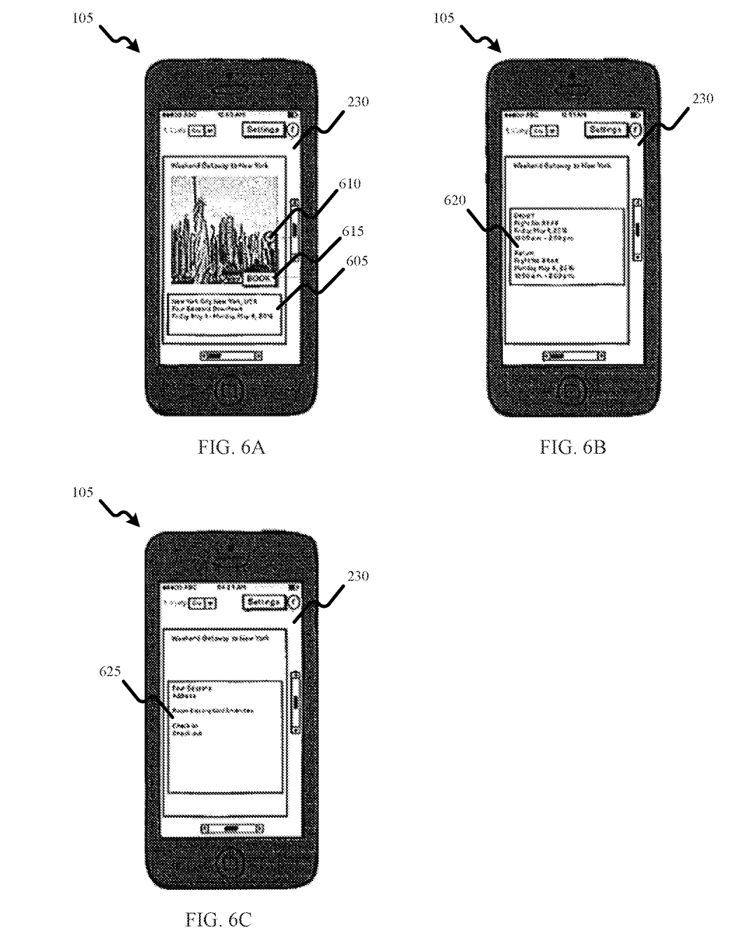

FIG. 6A is an example view of a first trip package displayed on the user interface 230. The user interface 230 displays, for example, a first set of basic information 605 for the first trip package (for example, destination location and travel dates), a “trip details” virtual button 610, and a “book trip” virtual button 615. The electronic processor 205 displays a second set of basic information for the first trip package when the “trip details” virtual button 610 is selected. For example, the electronic processor 205 detects, based on signals received from the user interface 230, when a user's finger touches the “trip details” virtual button 610 on the user interface 230, and displays the second set of basic information for the first trip package on the user interface 230. The second set of basic information includes, for example, first information 620 about the transport link resource allocations included in the first trip package (for example, departure dates, departure times, and arrival times, as illustrated in FIG. 6B). The second set of basic information also includes, for example, second information 625 about the lodging allocation included in the first trip package (for example, hotel name, hotel address, room description, hotel amenities, check-in, and check-out, as illustrated in FIG. 6C).

Returning to FIG. 4, at block 415, a trip booking request is received from a user. The electronic processor 205 transmits the trip booking request for a trip package to the server 110 when the “book trip” virtual button 615 is selected. For example, the electronic processor 205 detects, based on signals received from the user interface 230, when a user's finger touches the “book trip” virtual button 615 on the user interface 230, and transmits the trip booking request for a first trip package to the server 110 via the transceiver 215. In some embodiments, no additional user input is required to book a trip package after the user has selected the “book trip” virtual button 615 (i.e., one-click booking). For example, the user is not required to confirm a trip booking request after selecting the “book trip” virtual button 615.

At block 420, the transport link resource allocation of the first trip package is allocated to the first user. For example, the server electronic processor 305 transmits one or more transport reservation signals to one or more of the transport databases 115 requesting air travel reservations. The transport reservation signal indicates, for example, flight numbers, travel dates, biographical data about the traveler (for example, name, birthday, mailing address, email address, phone number, loyalty program identifier, and known traveler number), and traveler preferences (for example, aisle or window seat). In some embodiments, the server electronic processor 305 determines traveler information and traveler preferences for the transport reservation signals based on a user profile of the first user stored, for example, in the server memory 310.

At block 425, the lodging allocation of the first trip package is allocated to the first user. For example, the server electronic processor 305 transmits one or more lodging reservation signals to one or more of the lodging databases 120 requesting a hotel reservation. The lodging reservation signal indicates, for example, a hotel name, travel dates, biographical data about the hotel guest (for example, name, birthday, mailing address, email address, phone number and loyalty program identifier), and traveler preferences (for example, type of bed, room on high or low floor, and room near or away from elevators). In some embodiments, the server electronic processor 305 determines traveler information and traveler preferences for the lodging reservation signal based on a user profile of the first user stored, for example, in the server memory 310.

At block 430, a user financial time commitment is allocated to the first user. As described above, in some embodiments, a user financial time commitment includes a number of monthly payments received from a user. The server electronic processor 305 compares the user financial time commitment of the first trip package to a user financial time credit of the first user. When the user financial time commitment of the first trip package is less than or equal to the user financial time credit of the first user, the server electronic processor 305 reduces the user financial time credit of the first user by the user financial time commitment of the first trip package. For example, when the user financial time commitment of the first trip package is three months and the user financial time credit of the first user is four months, the server electronic processor 305 reduces the user financial time credit of the first user from four months to one month. Alternatively, when the user financial time commitment of the first trip package is greater than the user financial time credit of the first user, the server electronic processor 305 reduces the user financial time credit of the first user to zero and commits the first user to additional financial payments to make up the difference. For example, when the user financial time commitment of the first trip package is three months and the user financial time credit of the first user is two months, the server electronic processor 305 reduces the user financial time credit of the first user from two months to zero months and commits the first user to pay an additional month of payment. Thus, the next monthly payment of the first user will not increase the user financial time credit of the first user.

At block 435, reservation data is communicated to the first user through the user interface 230 over the communication network 135. Reservation data includes, for example, confirmation numbers, flight information (for example, airline names, flight numbers, arrival times, departure times, and seat assignments), and hotel information (for example, hotel name, hotel location, type of room booked, hotel amenities, check-in time, and check-out time). In some embodiments, responsive to receiving booking confirmations from the transport databases 115 and the lodging databases 120, the server electronic processor 305 determines and transmits the reservation data to one or more of the electronic user devices 105A, 105B, or 105C. The electronic processor 205 displays the reservation data to the user on the user interface 230 of the one or more electronic user devices 105A, 105B, and 105C.

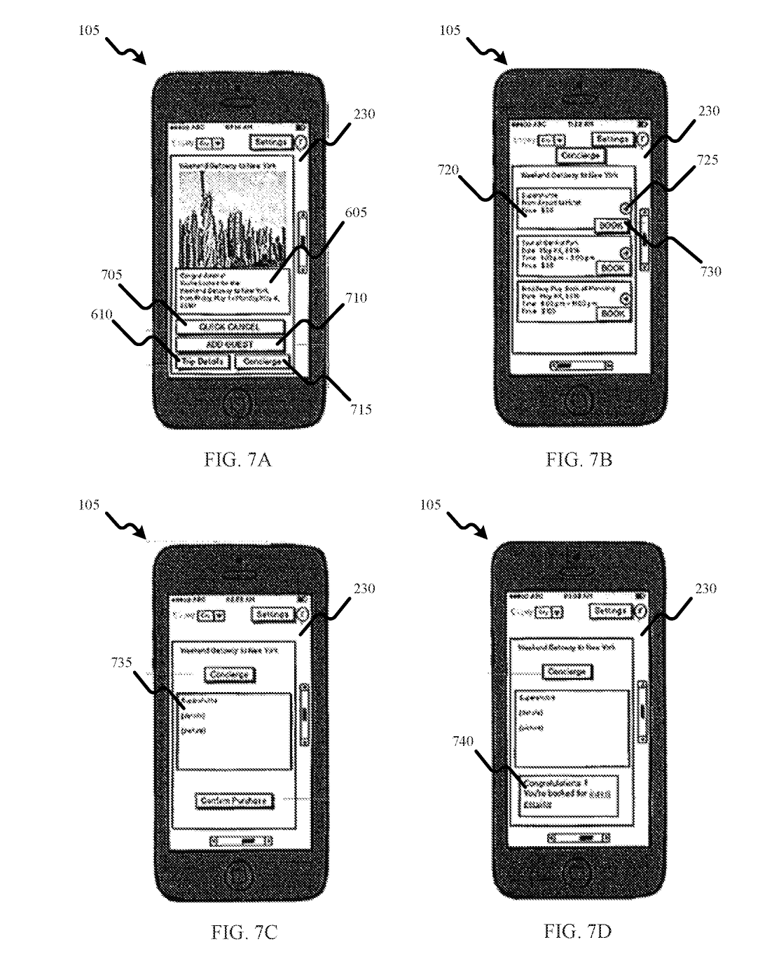

In some embodiments, the user is presented with additional options after booking a trip package. FIG. 7A illustrates an example screenshot of the user interface 230 after a first trip package has been booked. In FIG. 7A, the user interface 230 displays the first set of basic information 605 for the first trip package (for example, destination location and travel dates), the “trip details” virtual button 610, a “cancel trip” virtual button 705, an “add guest” virtual button 710, and a “concierge” virtual button 715.

In some embodiments, the electronic processor 205 displays the second set of basic information for the first trip package (described above in connection to FIGS. 6B and 6C) on the user interface 230 when the “trip details” virtual button 610 is selected. Alternatively or in addition to the second set of basic information, the electronic processor 205 displays all or a portion of the reservation data for the first trip package (described above in connection to block 435 of FIG. 4) on the user interface 230 when the “trip details” virtual button 610 is selected.

A user may want to cancel a booked trip package. For example, the user may have inadvertently selected the “book trip” virtual button 615. The electronic processor 205 transmits a signal to the server 110 to cancel a booked trip package when the “cancel trip” virtual button 705 is selected. For example, the electronic processor 205 detects, based on signals received from the user interface 230, when a user's finger touches the “cancel trip” virtual button 705 on the user interface 230, and transmits a signal to the server 110, via the transceiver 215 indicating a request to cancel a booked trip package. In some embodiments, users are given a set period of time to cancel a trip package after booking. For example, users are given one hour to cancel a trip package after selecting the “book trip” virtual button 615.

A user may want to bring a guest with them on a booked trip package (for example, a friend or significant other). The electronic processor 205 transmits a signal to the server 110 to add a guest to a booked trip package when the “add guest” virtual button 710 is selected. In some embodiments, the user provides guest information via the user interface 230. Guest information includes, for example, the guest's name, date of birth, gender, email address, and phone number. In some embodiments, the guest information provided by the user is added to the user's profile such that the guest information is accessed the next time the guest is added to a trip package by the user.

In some embodiments, activity allocations can be added to booked trip packages. Activity allocations include, among other things, restaurant reservations, museums tickets, entertainment tickets, sports tickets, or a combination thereof. The electronic processor 205 displays an inventory of activity allocations for a booked trip package on the user interface 230 when the “concierge” virtual button 715 is selected.

In some embodiments, the server 110 determines potential activities to offer users based in part on information received from the activity databases 125 over the communication network 135. The information received from the activity databases 125 includes, for example, names, descriptions, locations, prices, restrictions, operating days, and operating hours. From the determined potential activities, the server 110 selects an inventory of activities for a booked trip package based in part on user preferences, the destination location of the booked trip package, the travel dates of the booked trip package, or a combination thereof. For example, the server 110 selects an inventory of activities including museums located in the destination location for a trip package booked by a user whose user preferences indicate that the user enjoys visiting museums. In some embodiments, each activity included in the inventory of activities is associated with an activity allocation.

FIG. 7B illustrates an example inventory of activities displayed on the user interface 230. In FIG. 7B, for each of the inventory of activities, the user interface 230 displays basic information 720 for the activity (for example, an activity description, an activity date, an activity time frame, and an activity price), an “activity details” virtual button 725, and a “book activity” virtual button 730. As illustrated in FIG. 7C, the electronic processor 205 displays addition information 735 about an activity on the user interface 230 when an “activity details” virtual button 725 is selected. The addition information 735 includes, for example, a more detailed description of the activity, user reviews of the activity, a location of the activity, and restrictions (for example, age restrictions).

The electronic processor 205 transmits an activity booking request for an activity to the server 110 when a “book activity” virtual button 730 is selected. For example, the electronic processor 205 detects, based on signals received from the user interface 230, when a first user's finger touches the “book activity” virtual button 730 of a first activity on the user interface 230, and transmits the activity booking request for the first activity to the server 110 via the transceiver 215. Responsive to receiving the activity booking request, the server electronic processor 305 allocates an activity allocation of the first activity to the first user. For example, the server electronic processor 305 transmits one or more activity reservation signals to one or more of the activity databases 125 requesting an activity reservation. The activity reservation signal indicates, for example, biographical data of the guest (for example, name, birthday, mailing address, email address, and phone number).

In some embodiments, the server electronic processor 305 determines guest information for the activity reservation signal based on a user profile of the first user stored, for example, in the server memory 310. Also, the server electronic processor 305 allocates additional user financial time commitments to the first user responsive to receiving the activity booking request. In some embodiments, users can pay for booking activity requests without allocating additional user financial time commitments. For example, responsive to receiving an activity booking request from a first user, the server electronic processor 305 determines a designated financial account of the first user based on the user's stored profile, and transmits a request to charge the designated financial account for the booked activity. In some embodiments, the electronic processor 205 displays a booking confirmation 740 on the user interface 230 after an activity is booked, as illustrated in FIG. 7D.

As described above, the server electronic processor 305 selects the inventory of trip packages based in part on user preferences. In some embodiments, the server electronic processor 305 determines user preferences based in part on user-provided preference data, user trait data, observational data, incidentally-gathered data, or a combination thereof.

User-provided preference data includes information provided by users via the user interface 230. For example, the user interface 230 displays one or more user preference forms prompting users to provide information about their travel preferences. The user preference forms request, among other things, preferred trip frequency (for example, how often users want to take trips), preferred destination locations, preferred activities, and the amount of financial resources that users are willing to commit to trip packages. In some embodiments, the user preference forms also request time restrictions (for example, working days and hours), preferred trip types, preferred destination location types, user interests, preferred types of accommodations, preferred modes of transportation, preferred climates, or a combination thereof.

User trait data includes information collected by the consumer tracking databases 130. For example, many internet websites and software applications collect usage information about users. The consumer tracking databases 130 combine usage information from different sources to generate user trait data about specific users, groups of users, or both. User trait data includes information about users such as age group, gender, interests (for example, music, television programs, movies, books, and sports), disinterests, geographical region, travel habits, purchasing habits, travel preferences, clothing preferences, income level, and residential information.

Observational data includes data collected by the electronic user device 105 regarding user interaction with the trip booking application (or the trip booking internet website). In some embodiments, the observational data includes information regarding user viewership of the inventory of trip packages. For example, the observational data indicates durations of browsing sessions, times of day of browsing sessions, durations of viewing specific trip packages, durations of viewing specific types of trip packages. In some embodiments, the observational data also includes information regarding potential user interest in specific trip packages or types of trip packages. For example, the observational data indicates when a user forwards a trip package to another party such as a spouse.

Incidentally-gathered data includes data gathered from the electronic user device 105 relating to activities other than the trip booking application (or the trip booking internet website). In some embodiments, incidentally-gathered information includes locations of the electronic user device 105, software applications installed on the electronic user device 105, and internet websites accessed by the electronic user device 105.

In some embodiments, the server electronic processor 305 aggregates user-provided preference data, user trait data, observational data, and incidentally-gathered data collected for a group of users to determine user preferences. For example, in a group of one thousand users, the server electronic processor 305 can determine that four hundred users like to go to the beach, two hundred users like to ski, three hundred users like to listen to live music, and one hundred users like to visit museums. Thus, the server electronic processor 305 selects an inventory of trip packages including beach trip packages, skiing trip packages, live music trip packages, and museums trip packages.

In some embodiments, the server electronic processor 305 selects users to include in specific groups based on location. For example, the server electronic processor 305 determines a first user group including a plurality of users that are located near a first departure location. The server electronic processor 305 determines user preferences for the first user group and selects an inventory of trip packages from the first departure location for the first user group based in part on the determined user preferences of the first user group.

Each inventory of trip packages can include different types of trip packages (for example, beach trip packages and skiing trip packages). In addition, each inventory of trip packages can include a quantity of each different type of trip packages. For example, a first inventory of trip packages can include six beach trip packages and four skiing trip packages. As described above, the server electronic processor 305 allocates transport link resource allocations and lodging allocations responsive to receiving trip booking requests. In allocating the transport link resource allocations and the lodging allocations of a booked trip package, the server electronic processor 305 adjusts the inventory of trip packages to remove the booked trip package. For example, when one of four available beach trip packages is booked, only three beach trip packages remain available. In order to maintain a constant stock of appealing trip packages, the server electronic processor 305 periodically or continuously adjusts the inventory of trip packages.

In some embodiments, the server electronic processor 305 adjusts the inventory of trip packages based in part on pricing data for the transport link resource allocations and the lodging allocations of the inventory of trip packages. As described above, the server electronic processor 305 receives pricing data from the transport databases 115, the lodging databases 120, or both. The prices for transport link resource allocations and lodging allocations change over time. For example, the price for a specific airline flight may be $128 on Monday and $280 on Tuesday. In some embodiments, the server electronic processor 305 adjusts the inventory of trip packages to ensure that the total price for each trip package is less than or equal to a pricing threshold (for example, $400). This inventory adjustment can include the server electronic processor 305 altering trip (for example, exchanging a more expensive airline flight in a trip package with a less expensive airline flight). This inventory adjustment can also include the server electronic processor 305 removing trip packages from the inventory (for example, removing a trip package from the inventory when the total price of the trip package is greater than the pricing threshold). This inventory adjustment can also include the server electronic processor 305 replacing trip packages from the inventory (for example, replacing a first beach trip package having a total price greater than the pricing threshold with a second beach trip package having a total price less than the pricing threshold).

Alternatively or in addition, the server electronic processor 305 adjusts the inventory of trip packages based in part on current user interest. The server electronic processor 305 determines current user interest based on trends in recently received trip booking requests. For example, the server electronic processor 305 determines and adds additional beach trip packages to the inventory of trip packages when the server electronic processor 305 receives a large quantity of trip booking requests for beach trip packages. As a further example, the server electronic processor 305 may remove skiing trips when the server electronic processor 305 does not receive (or receives a low quantity of) trip booking requests for skiing trip packages.

Alternatively or in addition, the server electronic processor 305 adjusts the inventory of trip packages based in part on perceived user interest. The server electronic processor 305 determines perceived user interest based on user viewership of the current inventory of trip packages. In some embodiments, the server electronic processor 305 determines user viewership of the current inventory of trip packages based on observational data received from the electronic user device 105. For example, the server electronic processor 305 identifies a high interest level in beach trip packages when the observation data received indicates that a large of number of users are viewing beach trip packages on the electronic user device 105. As a further example, the server electronic processor 305 identifies a low interest level in skiing trip packages when the observation data received indicates that a small of number of users are viewing skiing trip packages on the electronic user device 105. In some embodiments, the server electronic processor 305 compares determined interest levels for trip types to a first threshold and adds additional trip packages of those trip types to the inventory of trip packages when the determined interest levels are above the first threshold. Alternatively or in addition, the server electronic processor 305 compares determined interest levels for trip types to a second threshold and removes trip packages of those trip types from the inventory of trip packages when the determined interest levels are below the second threshold.

The server electronic processor 305 also determines booking trends for individual users based in part on observational data, trip booking requests, or both. In some embodiments, the server electronic processor 305 compares a user's viewership of the inventory of trip packages (based on received observational data) to subsequently received trip booking requests in order to determine booking trends for the user. Booking trends for a user include, among other things, when the user typically views the inventory of trip packages, when the user typically books trip packages, and the average time duration between the user viewing a trip package on the user interface 230 and the server electronic processor 305 receiving a trip booking request from the user's electronic user device 105 for the viewed trip package. The server electronic processor 305 stores booking trends for users, for example, in the server memory 310. In some embodiments, the server electronic processor 305 adds booking trends of users to the users' profiles. After determining booking trends for a user, the server electronic processor 305 compares newly received observational data from the electronic user devices 105A to determined booking trends of the user in order to determine a booking probability factor (i.e., the probability that the user will eventually book a trip package).

For example, the server electronic processor 305 may determine (based on previously received observational data and trip booking requests) that a first user books a trip package 80% of the time after the first user views the trip package on the user interface 230 for a time period of greater than nine minutes. Thus, upon receiving observational data from the electronic user device 105A of the first user indicating that the first user has viewed a first trip package on the user interface 230 for a time period of ten minutes, the server electronic processor 305 determines an 80% booking probability factor that the first user will book the first trip package.

As a further example, the server electronic processor 305 may determine (based on previously received observational data and trip booking requests) that a second user books a trip package 90% of the time after the second user forwards the trip package to their spouse. Thus, upon receiving observational data from the electronic user device 105B of the second user indicating that the second user has forwarded a second trip package to their spouse, the server electronic processor 305 determines a 90% booking probability factor that the second user will book the second trip package.

In another example, the server electronic processor 305 may determine (based on previously received observational data and trip booking requests) that a third user books a trip package 75% of the time after the third user views the trip package twice in the same day. Thus, upon receiving observational data from the electronic user device 105C of the third user indicating that the third user has viewed a third trip package twice in the same day, the server electronic processor 305 determines a 75% booking probability factor that the third user will book the third trip package.

In some embodiments, the server electronic processor 305 adjusts the inventory of trip packages based in part on booking probably factors. As a basic example, upon determining that the booking probability factor for a first trip package is above a set threshold (for example, above 85%), the server electronic processor 305 adds one or more additional trip packages of the same type (or a similar type) to the inventory prior to receiving a trip booking request for the first trip package. As a more complex example, when two units of a first type of trip package are included in the inventory and the server electronic processor 305 determines (based on received observational data) that the booking probability factors for the two units from two different users are above the set threshold, the server electronic processor 305 adds one or more additional units of the first type of trip package to the inventory prior to receiving trip booking requests from the two users.

In some embodiments, the server electronic processor 305 provides status updates to users for the transport link resource allocations, the lodging allocation, and the activity allocations during a time period for which trip packages are booked. In other words, the server electronic processor 305 provides a user with status updates via the user interface 230 on their electronic user devices 105 while the user is on a booked trip package. Status updates includes, among other things, reminder alerts (for example, an alert to leave for an airport to make an upcoming scheduled flight), change alerts (for example, an alert indicating that the departure time for a scheduled flight has changed), and cancellation alerts (for example, an alert indicating that a booked activity have been cancelled due to inclement weather). In some embodiments, the server electronic processor 305 determines status updates based in part on incidentally-gathered data received from the electronic user devices 105A, 105B, and 105C. For example, the server electronic processor 305 determines a user's location based on incidentally-gathered data received from the electronic user device 105 of the user which indicates the location of the electronic user device 105. By comparing the user's location to the location of a scheduled event in the user's trip package (for example, a theater performance), the server electronic processor 305 determines the time when the user needs to leave their current location and start traveling over to the location of the scheduled event in order to arrive on time. At the determined time, the server electronic processor 305 provides a status update to the user via the user interface 230 which reminds the user to leave for the scheduled event. In some embodiments, the server electronic processor 305 provides ancillary services to users during a trip package. For example, upon determining that a user needs to leave for a scheduled event, the server electronic processor 305 transmits a ride-sharing booking request for the user.

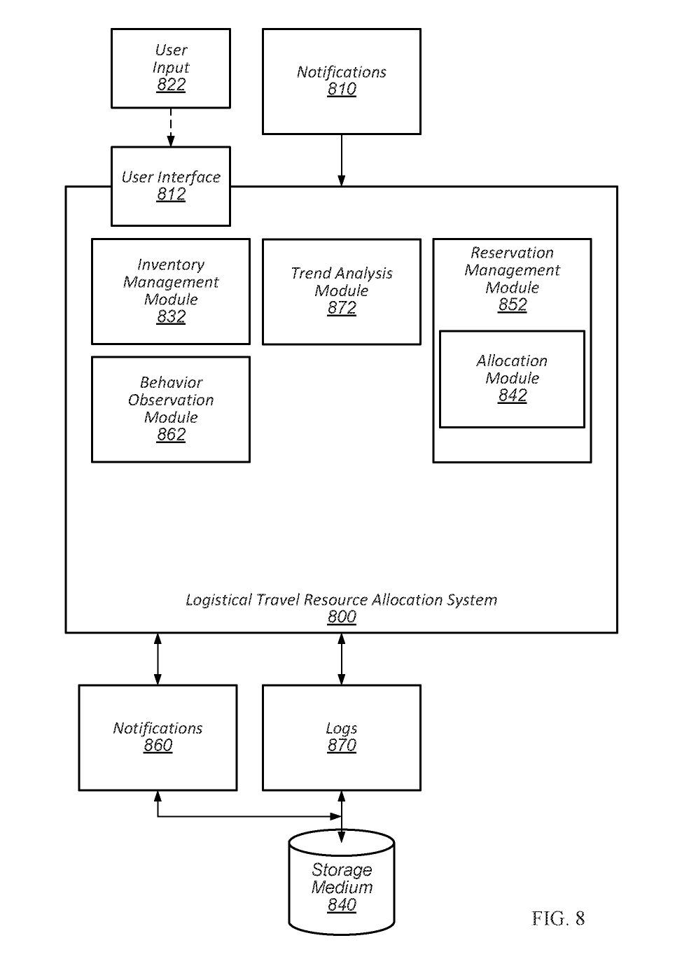

FIG. 8 is a module diagram of a system for selecting and allocating trip packages, in accordance with some embodiments. A logistical travel resource allocation system 800 may implement one or more of the techniques and tools illustrated in and described with respect to FIGS. 1-7D and FIG. 9. Logistical travel resource allocation system 800 may, for example, contain one or more of an inventory management module 832, an allocation module 842, a reservation management module 852, a behavior observation module 862, and a trend analysis module 872. FIG. 3 illustrates an example computer system on which embodiments of logistical travel resource allocation system 800 may be implemented. Logistical travel resource allocation system 800 receives an input 822, through the user interface 812, of one or more notifications 810 of available inventory for lodgings and logistical links, among other notifications. Inventory management module 832 may perform selecting, based in part on user preferences, an inventory of trip packages including transport link resource allocations between a departure location and a plurality of destination locations, and lodging allocations for the plurality of destination locations.

Reservation management module 852 may perform, responsive to receiving a trip booking request from the user for a first trip package included in the inventory of trip packages allocating a transport link resource allocation and a lodging allocation of the first trip package to the user, allocating a user financial time commitment to the user, and communicating reservation data to the user through the user interface over the communication network as notifications 860, which are recorded in logs 870 in a data store on storage medium 840.

Behavior observation module 862 may perform retrieving a first set of observational data from a memory, the first set of observational data indicating user viewership of the inventory of trip packages and having been stored prior to receiving the trip booking request.

Trend analysis module 872 may perform determining a booking probability factor based in part on the booking trend for the user and the second set of observational data.

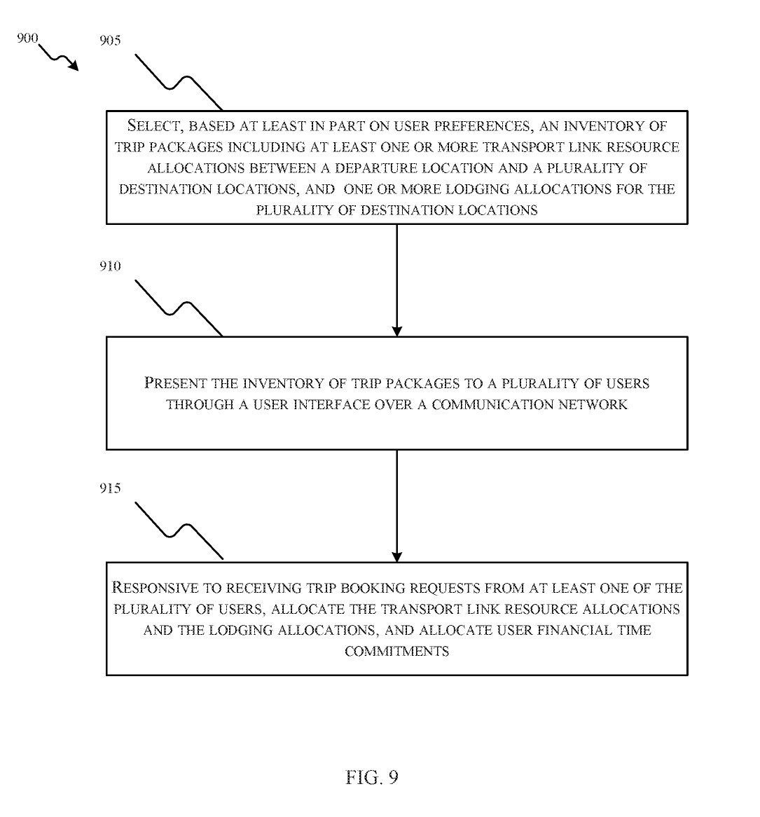

FIG. 9 is a flowchart of a method 900 of selecting and allocating trip packages, in accordance with some embodiments. At block 905, based at least in part on user preferences, an inventory of trip packages including at least one or more transport link resource allocations between a departure location and a plurality of destination locations, and one or more lodging allocations for the plurality of destination locations is selected. At block 910, the inventory of trip packages is presented to a plurality of users through a user interface over a communication network. At block 915, responsive to receiving trip booking requests from at least one of the plurality of users, the transport link resource allocations and the lodging allocations and user financial time commitments are allocated.

This disclosure is not limited in its application to the examples provided, the embodiments discussed, or to the details of construction and the arrangement of components set forth in the foregoing description or drawings. The disclosure is capable of other embodiments and of being practiced or of being carried out in various ways. Various embodiments and features are set forth in the following claims.

What is claimed is:

1. A system for allocating logistical travel resources, the system comprising:
a server executing an inventory management module for selecting, based in part on user preferences, an inventory of trip packages including:
transport link resource allocations between a departure location and a plurality of destination locations, and
lodging allocations for the plurality of destination locations;
a user interface module for presenting the inventory of trip packages to a user through a user interface over a communication network; and
a reservation management module for, responsive to receiving a trip booking request from the user for a first trip package included in the inventory of trip packages:
allocating a transport link resource allocation and a lodging allocation of the first trip package to the user,
allocating a user financial time commitment to the user, and
communicating reservation data to the user through the user interface over the communication network.

2. The system of claim 1, further comprising:
instructions within the user interface module for, responsive to receiving the trip booking request, the user interface module:
presenting, to the user through the user interface over the communication network, an inventory of activities based on a destination location of the first trip package.

3. The system of claim 2, further comprising:
instructions within the reservation management module for, responsive to receiving an activity booking request from the user for a first activity included in the inventory of activities, the reservation management module:
allocating an activity allocation of the first activity to the user, and
allocating additional user financial time commitments to the user.

4. The system of claim 1, wherein the allocating the transport link resource allocation of the first trip package to the user further comprises:
retrieving biographical data of the user, the biographical data of the user having been stored prior to receiving the trip booking request; and
transmitting a transport reservation signal including at least a portion of the biographical data of the user.

5. The system of claim 4, wherein the biographical data of the user includes at least one selected from a group consisting of a name, a birthday, a loyalty program identifier, and a known traveler number.

6. The system of claim 1, further comprising:
a behavior observation module for retrieving a first set of observational data from a memory, the first set of observational data indicating user viewership of the inventory of trip packages and having been stored prior to receiving the trip booking request;
a trend analysis module for determining a booking trend for the user based in part on the first set of observational data and the trip booking request; and
a data store for storing the booking trend for the user in the memory.

7. The system of claim 6, wherein the inventory of trip packages is a first inventory of trip packages, wherein:
the user interface module is further configured for presenting a second inventory of trip packages to the user through the user interface over the communication network;
the behavior observation module is further configured for receiving a second set of observational data from the user interface over the communication network, the second set of observational data indicating the user viewership of the second inventory of trip packages; and
the trend analysis module is further configured for determining a booking probability factor based in part on the booking trend for the user and the second set of observational data.

8. The system of claim 1, wherein communicating the reservation data to the user further comprises:
providing status updates for the transport link resource allocations and the lodging allocations to the user through the user interface over the communication network.

9. A method for allocating logistical travel resources, the method comprising:
selecting, based at least in part on user preferences, an inventory of trip packages including at least:
one or more transport link resource allocations between a departure location and a plurality of destination locations, and
one or more lodging allocations for the plurality of destination locations;
presenting the inventory of trip packages to a plurality of users through a user interface over a communication network; and
responsive to receiving trip booking requests from at least one of the plurality of users:
allocating the transport link resource allocations and the lodging allocations, and
allocating user financial time commitments.

10. The method of claim 9, wherein the user preferences include at least one selected from a group consisting of trip types, user interests, and destination location types.

11. The method of claim 9, further comprising:
determining the user preferences based at least in part on:
user-provided preference data of the plurality of users received through the user interface over the communication network,
user trait data of the plurality of users received over the communication network from one or more consumer tracking databases, and
observational data of the plurality of users received through the user interface over the communication network.

12. The method of claim 11, further comprising:
determining the user preferences based at least in part on incidentally-gathered data received from electronic user devices of the plurality of users over the communication network.

13. The method of claim 9, further comprising:
receiving, through the user interface over the communication network, observational data indicating user viewership of the inventory of trip packages; and
adjusting the inventory of trip packages based at least in part on the observational data.

14. The method of claim 13, wherein adjusting the inventory of trip packages based in part on the observational data further comprising:
determining, based at least in part on the observational data, an interest level of a trip type included in the inventory of trip packages; and
adding additional trip packages of the trip type to the inventory of trip packages when the determined interest level is above a threshold.

15. The method of claim 14, wherein the threshold is a first threshold, wherein adjusting the inventory of trip packages based in part on the observational data further comprises:
removing trip packages of the trip type from the inventory of trip packages when the determined interest level is below a second threshold,
wherein the second threshold is less than the first threshold.

16. The method of claim 9, further comprising:
adjusting the inventory of trip packages based in part on pricing data for the transport link resource allocations and the lodging allocations of the inventory of trip packages.

17. The method of claim 9, wherein allocating the user financial time commitments further comprising:
comparing the user financial time commitments to user financial time credits of the plurality of users; and
committing the plurality of users to additional financial payments when the user financial time commitments are greater than the user financial time credits.

18. The method of claim 9, further comprising:
supplying, to the plurality of users through the user interface over the communication network, status updates for the transport link resource allocations and the lodging allocations during a time period for which trip packages are booked.

19. A computer program product in a computer readable medium for allocating logistical travel resources, the computer program product in a computer readable medium comprising instructions for:
selecting, based in part on user preferences, an inventory of trip packages including:
transport link resource allocations between a departure location and a plurality of destination locations, and
lodging allocations for the plurality of destination locations;
presenting the inventory of trip packages to a user through a user interface over a communication network; and
responsive to receiving a trip booking request from the user for a first trip package included in the inventory of trip packages:
allocating a transport link resource allocation and a lodging allocation of the first trip package to the user,
allocating a user financial time commitment to the user, and
communicating reservation data to the user through the user interface over the communication network.

20. The computer program product in a computer readable medium of claim 19, further comprising instructions for:
responsive to receiving the trip booking request:
presenting, to the user through the user interface over the communication network, an inventory of activities based on a destination location of the first trip package.
